(19) United States
(12) Patent Application Publication
(10) Pub. No.: US 2003/0067611 A1
(43) Pub. Date: Apr. 10, 2003

(54) Point-diffraction interferometer

(75) Inventor: Hugo Matthieu Visser, Utrecht (NL)

Correspondence Address: SUGHRUE MION, PLLC, 2100 Pennsylvania Avenue, NW, Washington, DC, 20037-3213, US

(73) Assignee: CARL ZEISS SEMICONDUCTOR MANUFACTURING TECHNOLOGIES AG

(21) Appl. No.: 10/224,401

(22) Filed: Aug. 21, 2002

(30) Foreign Application Priority Data
Aug. 24, 2001 (DE) 101 42 742.5

(51) Int. Cl. G01B 9/02

(52) U.S. Cl. 356/521

(57) ABSTRACT

A point-diffraction interferometer having a source (1) of electromagnetic radiation, a perforated mask (2) on its entrance end, an optics-testing space (4) into which the optics (9) to be tested may be inserted, elements (5, 6) that create a testing beam and a reference beam using a perforated mask (6) on its exit end, and a component (7, 8) that analyzes an interference pattern (16) created by superimposing its testing beam and reference beam. One-dimensional or two-dimensional arrays (12, 15) of nearly point-like through holes are incorporated into the perforated masks (2, 6) on the interferometer's entrance end and exit end. The interferometer has particular application to testing optical systems employed on photolithographic exposure systems.

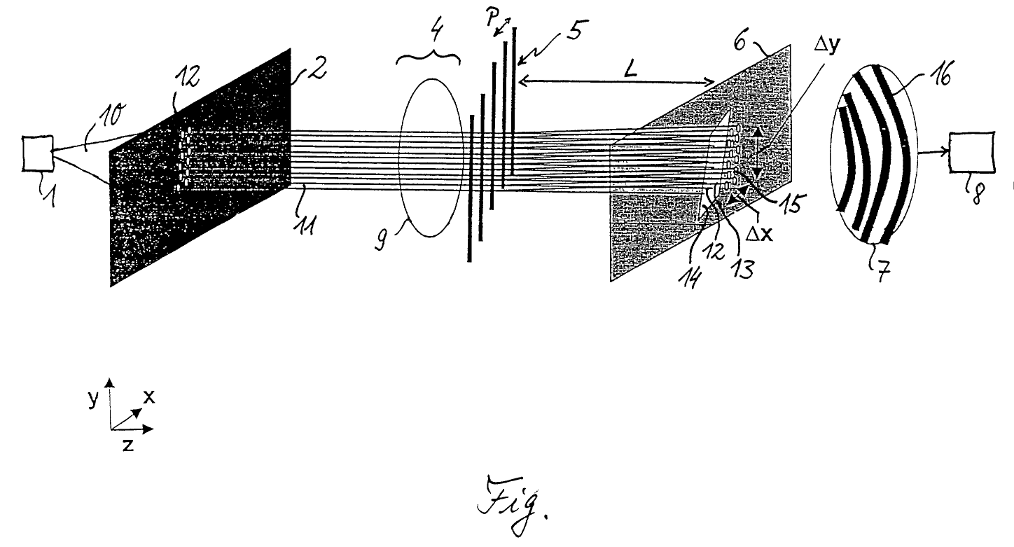

The following disclosure is based on German Patent Application No. 101 42 742.5 filed on Aug. 24, 2001, which is incorporated into this application by reference.

### BACKGROUND OF THE INVENTION

1. Field of the Invention

The invention relates to a point-diffraction interferometer. More particularly, the invention relates to a point-diffraction interferometer having a source of electromagnetic radiation, a perforated mask on its entrance end, following that source in the optical train, that yields spatially coherent radiation, an optics-testing space into which optics to be tested may be inserted, means for generating a testing beam that will be affected by the optical properties of every item of test optics inserted and a reference beam that will remain unaffected by the optical properties of any item of test optics inserted, where those means incorporate a perforated mask on their exit end, following that optics-testing space in the optical train, and analyzers for analyzing an interference pattern created by superimposing the testing beam and reference beam. It is well-known that point-diffraction interferometers of that type are used for testing the optical properties of optics, in particular, testing them for imaging errors, that have been inserted into the point-diffraction interferometer's optics-testing space for that purpose.

2. Description of the Related Art

Conventional point-diffraction interferometers of that type, which have been described in U.S. Pat. No. 5,835,217, employ a mask having a single through hole, which is also termed a “pin hole,” as the perforated mask on their entrance end in order that it will provide a source of coherent radiation, even when a light source that emits no coherent radiation is employed. That through hole thus has a suitably small diameter, preferably a diameter that is much less than the limits of resolution of the optics to be tested. If nothing to contrary is stated, the term “through holes,” as used here, shall mean such having nearly point-like dimensions that are small enough to yield coherent radiation.

In the case of these conventional point-diffraction interferometers, the perforated mask on their exit end also has a single through hole in order that it will provide a coherent reference beam on its far side. The latter is thus not affected by the optical properties of the optics to be tested, regardless of whether radiation incident on the through hole in the mask on the interferometer's exit end has passed through the optics to be tested or not. The reference beam is brought into interference with a testing beam that has been guided through the optics to be tested and has been affected by their optical properties in order that those optical properties, in particular, any imaging errors that the optics to be tested may cause, may be determined by analyzing the resultant interferogram, where the testing beam is guided past the perforated mask on the interferometer's exit end or through a transmitting section of that perforated mask whose dimensions are sufficiently large that no additional, interfering, diffraction effects occur. Beamsplitters may be arranged at a suitable location between the perforated masks on the interferometer's entrance end and exit end such that most of the intensity of the testing beam falls on a transmitting zone that lies outside the through hole while a reference beam portion falls on the through hole, for that purpose. Under one of the prospective implementations, these beamsplitters are formed from an additional perforated mask having a pair of through holes inserted between the perforated mask on the interferometer's entrance end and its optics-testing space. The perforated masks on the interferometer's entrance end and exit end are usually located in the object plane and image plane, respectively, of the optics to be tested.

U.S. Pat. No. 6,111,646 states special measures for calibrating such conventional point-diffraction interferometers, i.e., for conducting so-called “blank runs,” where the perforated mask having a single through hole that is employed during normal system operation is replaced by a single perforated calibration mask or a two-dimensional array of perforated calibration masks, each of which has a pair of through holes and an alignment window larger than those holes.

A major difficulty encountered with these conventional point-diffraction interferometers is that, during their operation, the utilizable intensity is limited to the intensity of the radiation supplied by the single through hole in the perforated mask on their entrance end.

Objects addressed by the invention include providing a point-contact interferometer of the type mentioned at the outset hereof that will allow achieving a relatively high intensity of the radiation utilizable for interferometric analyses and thereby also allow employing an extended source emitting spatially incoherent radiation.

### SUMMARY OF THE INVENTION

The invention solves these and other objects by providing a point-diffraction interferometer of that type in which the perforated masks on its entrance end and exit end each have a one-dimensional or two-dimensional array of through holes. The utilizable radiant intensity is correspondingly increased by these multiple through holes, and is many times that available in the case of conventional systems, which have only a single through hole on each mask. Duly allowing for the associated laws of optics, in particular, those related to the sizes and separations of the multiple through holes in relation to the wavelength range of the radiation employed and the limits of resolution of the optics to be tested, these multiple-aperture point-diffraction interferometers allow determining the optical properties of the optics involved, i.e., in particular, their imaging errors, from interferograms obtained by superimposing their testing beam, which will have been affected by the optical properties of the optics to be tested, and the reference beam provided by the multiple-aperture array on the perforated mask on their exit end.

In the case of another embodiment of the invention these through holes in the respective multiple-aperture masks form a prescribed, periodic array, which can simplify aligning the pair of multiple-aperture masks with respect to one another, orthogonal to the optical axis, compared to the case of aligning conventional systems equipped with single-aperture masks.

In the case of yet another embodiment of the invention a beamsplitting diffraction grating is provided and the respective one-dimensional or two-dimensional arrays of through holes consist of one or more individual arrays whose extensions along that direction along which the image of the multiple-aperture array on the interferometer's entrance end is shifted with respect to its original image as a reference are restricted in order to provide, in a relatively simple manner, that no additional effects due to mixing of diffracted radiation of differing orders will occur.

In the case of yet another beneficial embodiment of the invention, one-dimensional or two-dimensional arrays consisting of as many as 10⁶ through holes are employed on each multiple-aperture mask.

A beneficial embodiment of the invention is depicted in the FIGURE and will be described below.

### BRIEF DESCRIPTION OF THE DRAWING

The sole FIGURE depicts a schematized representation of a point-diffraction interferometer having a multiple-aperture mask on its entrance end and exit end.

### DETAILED DESCRIPTION OF THE PREFERRED EMBODIMENT

The point-diffraction interferometer depicted in the FIGURE includes a source 1 of electromagnetic radiation, a multi-aperture mask 2 on its entrance end, an optics-testing space 4, a diffraction grating 5 employed as a beamsplitter, a multi-aperture mask 6 on its exit end, and analytical devices that include a radiation detector 7, followed by a signal-analyzer unit 8, in that order, in its beam path. The respective optics to be tested, which may be, for example, optics employed on a photolithographic exposure system, such as a projection lens that is employed on such systems for imaging patterns on a mask onto wafers, are inserted into its optics-testing space. The perforated mask 2 on its entrance end is situated in the object plane of the optics 9 to be tested and the perforated mask 6 on its exit end is situated in the image plane thereof.

The optics 9 inserted into the optics-testing space are tested by the point-diffraction interferometer in order to determine their optical properties, in particular, any imaging errors that they may cause. The radiation for which the optics 9 to be tested are intended to be used is thus preferably employed for testing purposes. In cases where optical systems employed on photolithographic exposure systems, are to be tested, this may be, among other possibilities, visible light or UV-radiation, in particular, radiation from the extreme-ultraviolet (EUV) spectral region. Applicable as the associated radiation source 1 in the latter case are, e.g., a plasma source emitting EUV-radiation or a synchrotron source. The spatial extension of the radiation source 1 is not critical, since the spatial coherence of the radiation employed will, in any event, be assured by the perforated mask 2 on the interferometer's entrance end that follows it in the optical train.

The latter creates spatially coherent radiation 11 that is guided through the optics-testing space 4, and thus through the optics 9 to be tested, at its exit from the radiation 10 supplied to it by the radiation source 1. In order to provide that coherent radiation, the perforated mask 2 on the interferometer's entrance end has a two-dimensional array 12 of through holes whose nearly point-like dimensions are so small that every individual through hole emits spatially coherent radiation, in keeping with the definition of the term “through hole” stated above.

After the spatially coherent radiation 11 exits the optics-testing space 4, the grating 5, whose rulings are parallel to a y-direction, creates therefrom an undeflected testing portion 11 of that radiation and a reference portion 13 of that radiation that is deflected with respect to the testing portion 11 of that radiation along an x-direction that is orthogonal to the y-direction, where both the x-direction and the y-direction are orthogonal to a z-direction, which represents the system's optical axis. In other words, the testing portion of that radiation and the reference portion of that radiation represent radiation portions of two neighboring diffraction maxima of the grating 5.

The testing portion 11 of that radiation passes through a transmitting section of the perforated mask 6 on the interferometer's exit end that is indicated by a bright rectangular window 14 in the FIGURE and strikes the detector unit 7 in the form of a testing beam. The reference portion 13 of that radiation strikes a section of the perforated mask 6 on the interferometer's exit end that is adjacent to the transmitting section 14 of the testing beam in the x-direction, into which section a two-dimensional array 15 of through holes that corresponds to the array 12 of through holes on the perforated mask 2 on the interferometer's entrance end has been formed.

This array 15 of through holes on the interferometer's exit end thus creates a coherent reference beam that thereafter will no longer be affected by the optical properties of the optics 9 to be tested, as would be the case for conventional systems having single-aperture perforated masks, from the incident reference portion of the spatially coherent radiation, which is affected by the optical properties of the optics 9 to be tested. However, the section 14 on the perforated mask 6 on the interferometer's exit end that transmits the testing beam has been chosen large enough that it transmits virtually the entire testing beam without noticeable vignetting effects so that the testing beam 11 will retain the information on the optical properties and, in particular, any imaging errors, of the optics 9 to be tested that it conveys, even after it has passed through the perforated mask 6 on the interferometer's exit end.

There will thus be an interference pattern 16, from which the analyzer unit 8 can extract the optical properties and, in particular, any imaging errors, of the optics 9 to be tested, formed at the detector unit 7 by superimposing the testing beam, which will have been affected by the optical properties of the optics 9 to be tested and the reference beam, which will be mutually coherent with the testing beam and unaffected by the optical properties of the optics 9 to be tested. Regarding the details of suitable analytical strategies, reference may be made to those employed in the case of conventional systems employing single-aperture perforated masks.

The point-diffraction interferometer shown thus differs from known systems in that it employs multiple-aperture masks 2, 6 having two-dimensional arrays 12, 15 of through holes instead of single-aperture masks, each of which has a single through hole. This multiplication of the number of through holes 12, 15 on the interferometer's entrance end and exit end has the advantage that a corresponding multiple of the radiant intensity utilizable for investigating the optics 9 to be tested will be available, without having to sacrifice the necessary coherence properties. Although this approach yields somewhat more complex interference patterns 16 than in the case where single-aperture perforated masks are employed, the resultant interference patterns are readily analyzable employing conventional, modern, detector and analyzing units, and the benefits of having utilizable radiant intensities that are many times those available with single-aperture perforated masks far outweigh any disadvantages arising from the more complex interference patterns. Arrays 12, 15 of as many as 10⁵ or 10⁶ through holes may typically be arranged on either of the perforated masks 2, 6.

It will be beneficial if each array 12, 15 of through holes is arranged in a prescribed, periodic, pattern, e.g., a rectangular or hexagonal pattern, which will increase the alignment tolerances for the arrays 12, 15 of through holes on the interferometer's entrance end and exit end with respect to one another compared to the case of conventional, single-aperture, perforated masks. When creating the arrays 12, 15 of through holes, it will be beneficial to make certain that the condition is met that in the image plane, i.e., in the plane of the perforated mask 6 on the interferometer's exit end, the array of through holes should be confined to a section having extensions of Δx along the x-direction and Δy along the y-direction which extension along the x direction, Δx, is less than the distance, Δ, between the image of a given through hole 12 on the perforated mask on the interferometer's entrance end and its associated original, reference, image. This distance, Δ, corresponds to the distance between neighboring diffraction maxima of the diffraction grating 5 and, in the case of the system shown, is given by the relation Δ=Lλ/P, where L is the distance between the diffraction grating 5 and the perforated mask 6 on the interferometer's exit end, i.e., between the diffraction grating 5 and the image plane, λ is the wavelength of the radiation employed, and P is the grating constant of the diffraction grating 5.

The extension in the image plane of these arrays of through holes along the x-direction is limited by the size of the image field of the optics 9 to be tested. Similar applies to their extension along the x-direction, in the event that the extension of the image field of those optics 9 along the x-direction is less than the displacement, Δ, of the images of through holes along the image plane. If, however the extension of the image field of the optics 9 to be tested along the x-direction is larger than many times the displacement, Δ, of the images of through holes along the image plane, the entire array may be periodically repeated the same number of times along the x-direction, which will allow extending the utilizable size of the source on the image plane of the optics 9 to be tested. In particular, this will allow configuring the arrays of through holes on the respective multiple-aperture masks from rows of several individual arrays spaced at the associated periodic interval along the x-direction.

Conventional discontinuous phase shifting by correspondingly translating the diffraction grating 5 along the x-direction may be employed, if necessary.

It should be obvious that, in addition to the aforementioned embodiments, the invention also covers other embodiments that follow from the various types of conventional single-aperture-mask systems by replacing their single-aperture masks with multiple-aperture masks, each of which has a two-dimensional array of through holes, preferably consisting of a large number through holes. For example, the diffraction grating 5 may be positioned at any other location between the perforated masks 2, 6 on the interferometer's entrance end and exit end and/or replaced by some other type of beamsplitting optical element. In many cases, the diffraction grating 5 is positioned ahead of the optics 9 to be tested. The beamsplitting optical element may be missing, in which case the array of through holes on the perforated mask on the interferometer's exit end will have to be arranged within the confines of a partially transparent window for transmitting the testing beam located on the perforated mask on the interferometer's exit end. Instead of the two-dimensional arrays of through holes shown in the sample embodiment, alternative embodiments of the invention might employ one-dimensional arrays of through holes, i.e., arrays consisting of a single row of through holes, in which case, once again, a rather large number of holes, e.g., 10³ to 10⁶ holes, might preferably be provided.

Point-diffraction interferometers according to the invention are particularly well-suited to testing the optical systems of photolithographic exposure systems that employ, e.g., visible light or UV-radiation.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all changes and modifications as fall within the spirit and scope of the invention, as defined by the appended claims, and equivalents thereof.

Patent claims

I claim:

1. A point-diffraction interferometer comprising:
a source (1) of electromagnetic radiation,
a perforated mask (2) on an entrance end following the source in the optical train, that yields spatially coherent radiation (11),
an optics-testing space (4) into which optics (9) to be tested are inserted,
means (5, 6) for generating a testing beam that is affected by the optical properties of the test optics inserted and a reference beam that remains unaffected by the optical properties of the test optics inserted, where the means include a further perforated mask (6) on an exit end of the means, following the optics-testing space in the optical train, and
analyzers (7, 8) for analyzing an interference pattern (16) created by superimposing the testing beam and the reference beam, wherein
one-dimensional or two-dimensional arrays of through holes (12, 15) are incorporated into the perforated mask (2) on the entrance end and the perforated mask (6) on the exit end.

2. A point-diffraction interferometer according to claim 1, wherein the one-dimensional or two-dimensional arrays of through holes have prescribed, periodic arrangements of through holes (12, 15).

3. A point-diffraction interferometer according to claim 1, wherein the means for generating the testing beam and the reference beam incorporate a diffraction grating (5) and each of the arrays of through holes comprises one or more individual arrays, each of which has an extension (Δx) along an x-direction, along which the image of each through hole (12) on the entrance end is shifted relative to an associated original image, lying in the image plane of the optics to be tested that is less than the distance (Δ) between the image of the through hole and its original, reference image, measured along the x-direction.

4. A point-diffraction interferometer according to claim 1, wherein each of the one-dimensional or two-dimensional arrays of through holes contains between about 10⁵ and about 10⁶ through holes.

5. A point-diffraction interferometer according to claim 2, wherein each of the one-dimensional or two-dimensional arrays of through holes contains between about 10⁵ and about 10⁶ through holes.

6. A point-diffraction interferometer according to claim 3, wherein each of the one-dimensional or two-dimensional arrays of through holes contains between about 10⁵ and about 10⁶ through holes.

7. A point-diffraction interferometer comprising:
a source of electromagnetic radiation;
a first perforated mask receiving the electromagnetic radiation and out-putting spatially coherent radiation;
an optics-testing space configured to receive test optics;
an output of a testing beam that is affected by optical properties of the test optics and of a reference beam that is unaffected by the optical properties of the test optics, where said beam output includes a second perforated mask; and
an analyzer that analyzes an interference pattern created by superimposing the testing beam and the reference beam; wherein
said first perforated mask and said second perforated mask comprise an array of through holes extending in at least one direction.

8. A point-diffraction interferometer according to claim 7, wherein each said perforated mask comprises greater than 10³ of the through holes.
